(19) United States
(12) Patent Application Publication
(10) Pub. No.: US 2011/0308151 A1
(43) Pub. Date: Dec. 22, 2011

(54) Framework for Plants

(75) Inventor: Tony Wu, Chang-Hua (TW)

(73) Assignee: PRO-JOINER CO., LTD., Chang-Hua (TW)

(21) Appl. No.: 12/817,130

(22) Filed: Jun. 16, 2010

(51) Int. Cl. A01G 9/12

(52) U.S. Cl. 47/46

(57) ABSTRACT

Disclosed is a framework for supporting plants. The framework consists of at least two building units. Each of the building units includes a ferrule-forming segment and posts. The ferrule-forming segment includes a bow, a boss formed at an end of the bow, a boss-receiving ring formed at another end of the bow, post-receiving rings formed on the bow, and anchors formed on the bow. Each of the posts is fit in a related one of the post-receiving rings.

### BACKGROUND OF INVENTION

1. Field of Invention

The present invention relates to a framework for supporting plants and, more particularly, to a building unit that can be connected to another building unit to form such a framework.

2. Related Prior Art

Referring to FIG. 1, the stem of an herbaceous plant 1 or a vine, which tends to bend because of gravity, is often tied to a rod 2 with a wire 3, a ring or a clip. Thus, the bending of the herbaceous plant 1 is avoided. However, the stem of the herbaceous plant 1 could be cut or bent when the wire 3, ring or clip is provided around it. Moreover, it takes quite some time to provide the wire 3, ring or clip around the stem of the herbaceous plant 1.

There has been devised a conventional framework including a ring for circling an herbaceous plant. The conventional framework confines the growth of the herbaceous plant within an area. However, the conventional framework cannot well support the stem of the herbaceous plant.

The present invention is therefore intended to obviate or at least alleviate the problems encountered in prior art.

### SUMMARY OF INVENTION

It is the primary objective of the present invention to provide a building unit that can be joined with another building unit to form a framework for supporting plants.

To achieve the foregoing objective of the present invention, the building unit includes a ferrule-forming segment and posts. The ferrule-forming segment includes a bow, a boss formed at an end of the bow, a boss-receiving ring formed at another end of the bow, post-receiving rings formed on the bow, and anchors formed on the bow. Each of the posts is fit in a related one of the post-receiving rings.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a perspective view of a plant tied to a rod by a wire according to the prior art;

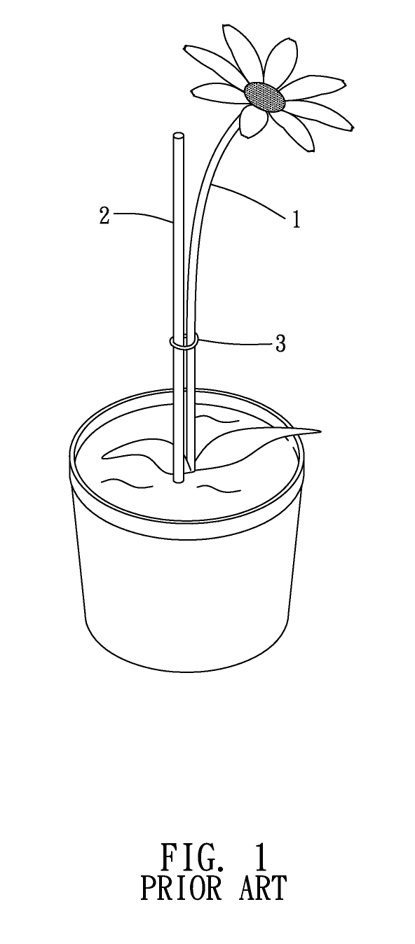

FIG. 2 is an exploded view of a building unit of a framework for supporting plants according to the preferred embodiment of the present invention;

FIG. 3 is a perspective view of a ferrule-forming segment of the building unit shown in FIG. 2;

FIG. 4 is a perspective view of two plants supported by a framework consisting of two building units as the one shown in FIG. 2;

FIG. 5 is a perspective view of vine-supporting rods connected to the framework shown in FIG. 4;

FIG. 6 is a top view of a framework consisting of three building units as the one shown in FIG. 2;

FIG. 7 is a partial, top view of a framework consisting of many building units as the one shown in FIG. 2; and

FIG. 8 is a top view of a framework consisting of three pairs of building units as the one shown in FIG. 2.

### DETAILED DESCRIPTION OF PREFERRED EMBODIMENT

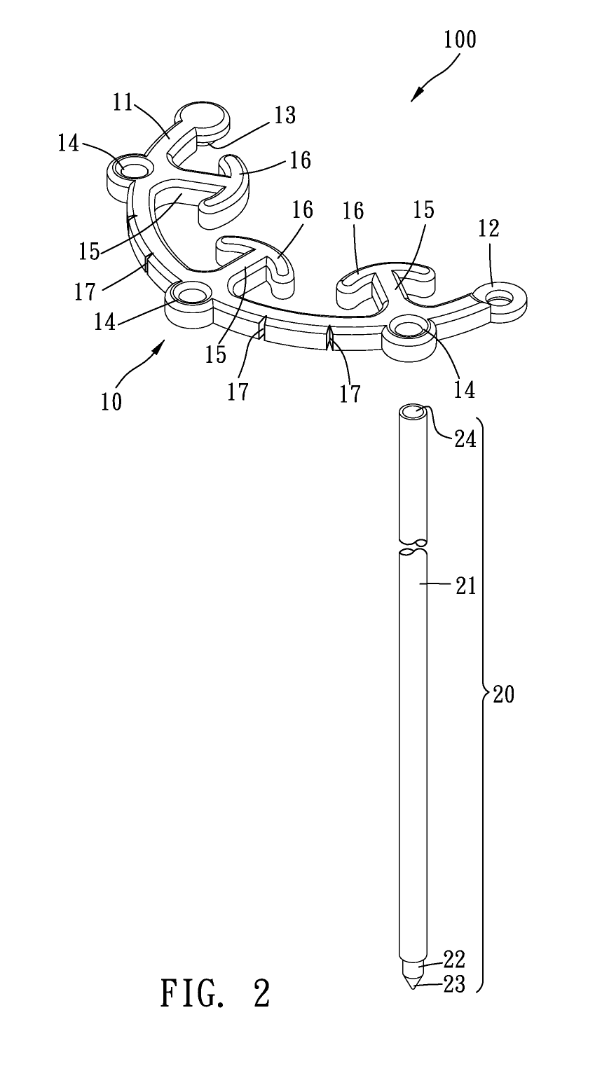

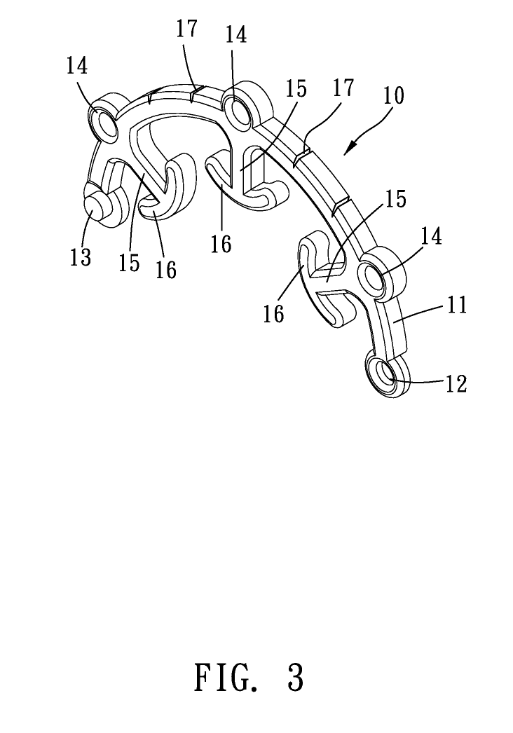

Referring to FIGS. 2 and 3, there is shown a building unit 100 that can be joined with another building unit 100 to form a framework for supporting plants according to the preferred embodiment of the present invention. The building unit 100 includes a ferrule-forming segment 10 and posts 20 (although only one is shown).

The ferrule-forming segment 10 includes a bow 11, a boss-receiving ring 12, a boss 13, post-receiving rings 14, anchors and notches 17. The bow 11 extends along an arc and, more particularly, along half a circle. The boss-receiving ring 12 is formed at an end of the bow 11, and the boss 13 is formed at another end of the bow 11. The boss-receiving ring 12 is made corresponding to the boss 13. The internal diameter of the boss-receiving ring 12 is marginally smaller than or identical to the diameter of the boss 13. The boss-receiving ring 12 is defined about an axis in parallel to another axis along which the boss 13 extends.

The post-receiving rings 14 are located along the bow 11. Preferably, the post-receiving rings 14 are formed on an external side of the bow 11. The post-receiving rings 14 are made corresponding to the posts 20. The internal diameter of the post-receiving rings 14 are marginally smaller than or identical to the diameter of the posts 20.

Each of the anchors includes a radial extension 15 extending from an internal side of the bow 11 and an arched extension 16 extending from the radial extension 15. The arched extension 16 includes two halves extending toward the bow 16 from two opposite sides of the radial extension 15.

The notches 17 are made in an external side of the bow 11. Each of the notches 17 includes a closed end and an open end. The width of each of the notches 17 gets larger towards the open end from the closed end. Therefore, each of the notches 17 looks like a “V” in a top view of the ferrule-forming segment 10.

Each of the posts 20 includes a shank 21, an insert 22 formed at an end of the shank 21 and a socket 24 formed at an opposite end of the shank 21. The insert 22 is made corresponding to the socket 24. The internal diameter of the socket 24 is marginally smaller than or identical to the diameter of the insert 22. The insert 22 includes a point 23.

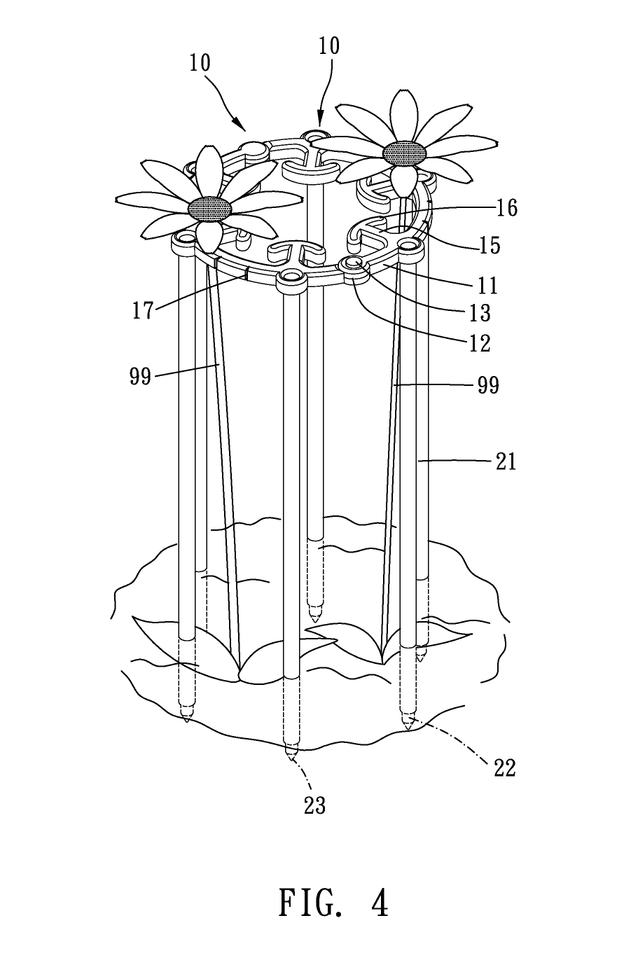

Referring to FIG. 4, two plants 99 are supported by a framework consisting of two building units 100 as the one shown in FIGS. 2 and 3. The boss 13 of the ferrule-forming segment 10 of the first building unit 100 is fit in the boss-receiving ring 12 of the ferrule-forming segment 10 of the second building unit 100. Thus, the ferrule-forming segments 10 of the first and second building units 100 form a circular ferrule for confining the plants 99. Each of the posts 20 is fit in a related one of the post-receiving rings 14. The insert 22 of each of the posts 20 is inserted in the earth. The insertion of the insert 22 in the earth is easy because of the point 23. The anchors confine the stems of the plants 99.

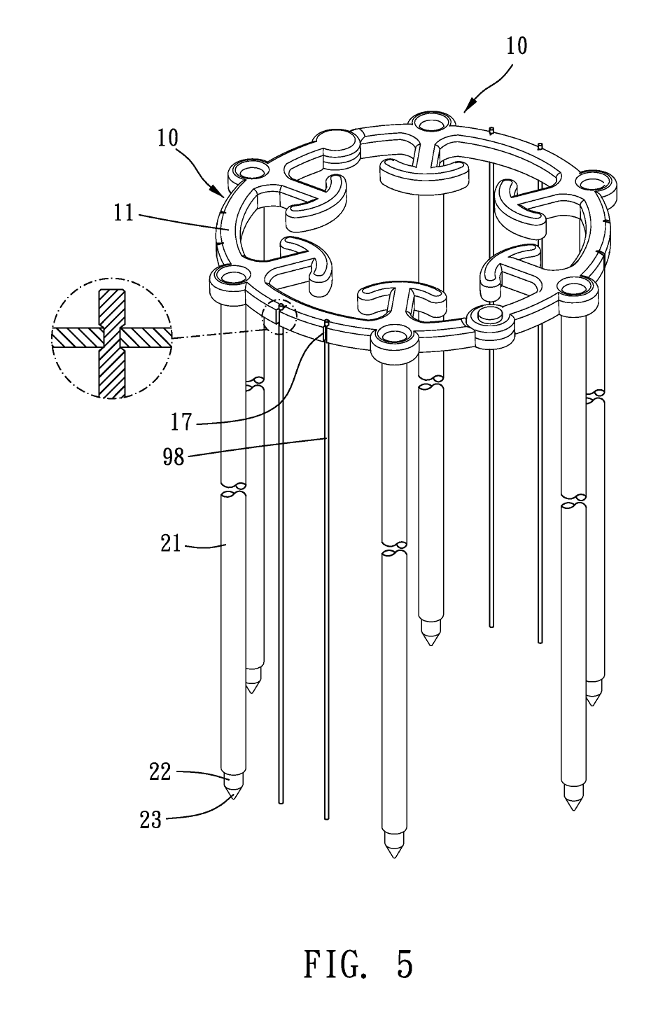

Referring to FIG. 5, an upper section of a vine-supporting rod 98 is fit in each of the notches 17. Thus, the vine-supporting rods 98 are connected to the framework. A lower end of each of the vine-supporting rods 98 is inserted in the earth. The vine-supporting rods 98 can support vines.

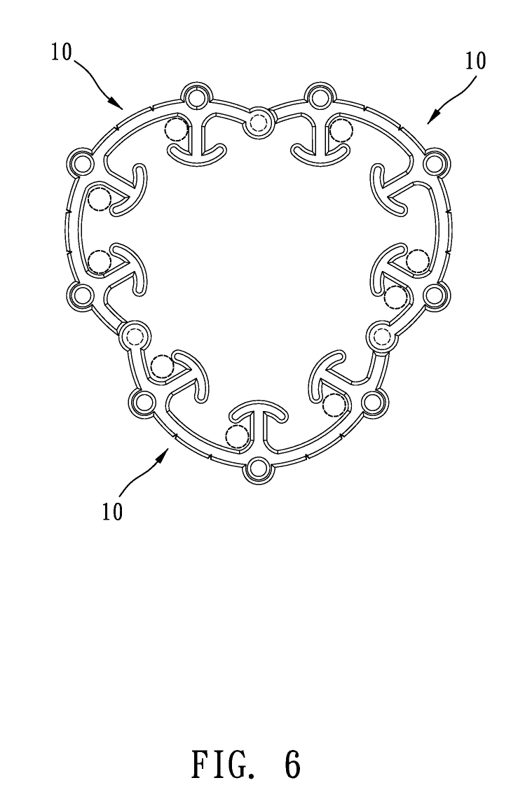

Referring to FIG. 6, a framework consists of three building units 100 as the one shown in FIG. 2. The ferrule-forming segments 10 of the building units 100 form a ferrule that includes three lobes. The framework shown in FIG. 6 can support more plants 99 than the framework shown in FIG. 2 can.

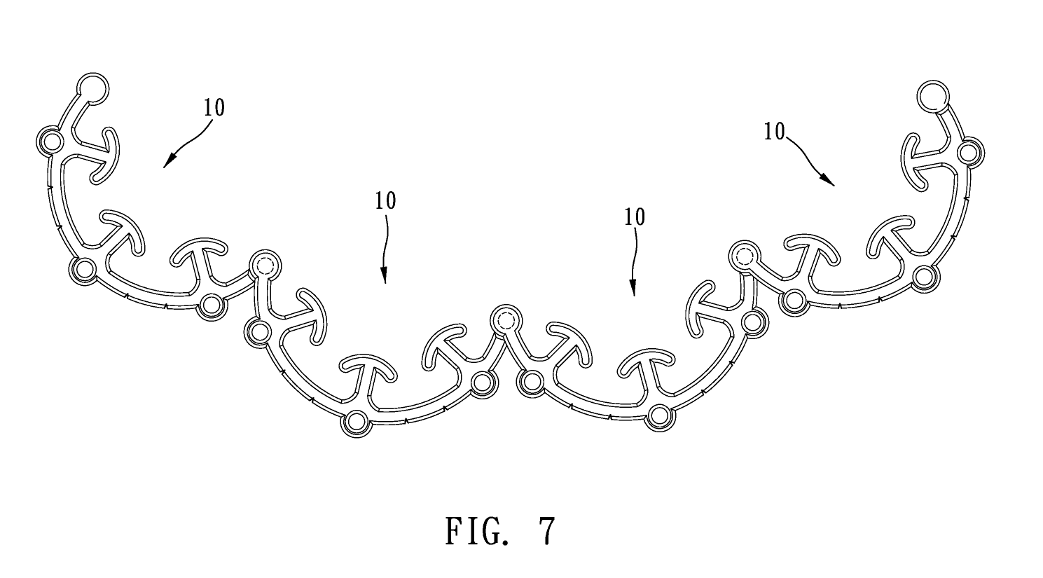

Referring to FIG. 7, a framework consists of many building units 100 as the one shown in FIG. 2. The ferrule-forming segments 10 of the building units 100 form a ferrule that includes many lobes. The framework shown in FIG. 7 can support more plants 99 than the framework shown in FIG. 6 can.

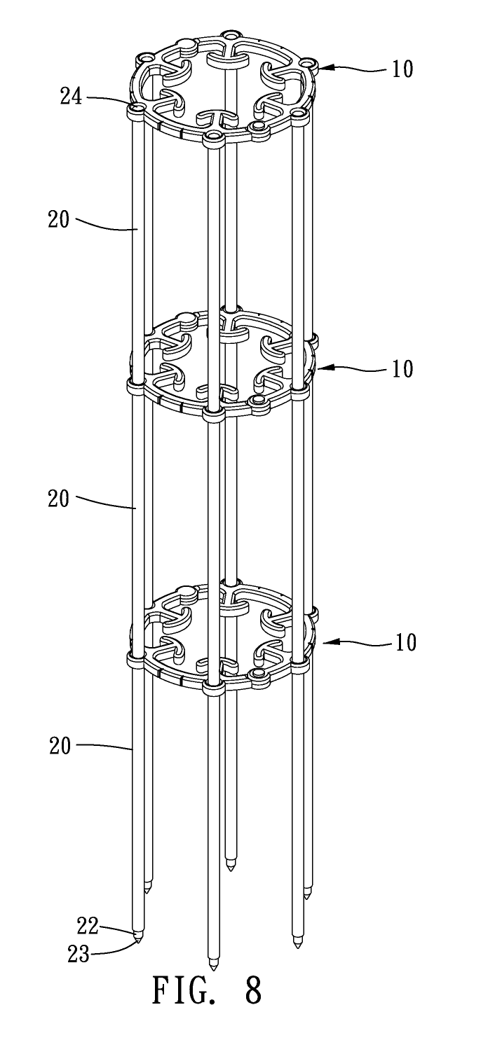

Referring to FIG. 8, a framework includes three pairs or layers of building units 100 as the one shown in FIG. 2. That is, the framework shown in FIG. 8 consists of three frameworks as the one shown in FIG. 4. The inserts 22 of the posts 20 of the upper pair of building units 100 are fit in the sockets 24 of the posts 20 of the middle pair of building units 100. The inserts 22 of the posts 20 of the middle pair of building units 100 are fit in the sockets 24 of the posts 20 of the lower pair of building units 100. The inserts 22 of the posts 20 of the lower pair of building units 100 can be inserted in the earth. The framework shown in FIG. 8 can support taller plants than the framework shown in FIG. 2 can.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A building unit including:
a ferrule-forming segment including a bow, a boss formed at an end of the bow, a boss-receiving ring formed at another end of the bow, post-receiving rings formed on the bow, and anchors formed on the bow; and
posts each fit in a related one of the post-receiving rings.

2. The building unit according to claim 1, wherein the bow extends along half a circle.

3. The building unit according to claim 1, wherein the boss includes a diameter identical to an internal diameter of the boss-receiving ring.

4. The building unit according to claim 1, wherein the posts include a diameter identical to an internal diameter of the post-receiving rings.

5. The building unit according to claim 1, wherein the anchors are formed on an internal side of the bow.

6. The building unit according to claim 1, wherein each of the anchors includes a radial extension formed on an internal side of the bow and an arched extension formed at a free end of the radial extension.

7. The building unit according to claim 6, wherein the arched extension includes two halves extending toward the bow from the radial extension.

8. The building unit according to claim 1, wherein the ferrule-forming segment includes notches defined in the bow for receiving vine-supporting rods.

9. The building unit according to claim 8, wherein the notches are defined in an external side of the bow.

10. The building unit according to claim 1, wherein each of the posts includes an insert formed at an end and a socket formed at an opposite end.

11. The building unit according to claim 10, wherein the insert includes a diameter identical to an internal diameter of the socket.

12. The building unit according to claim 10, wherein the insert is formed with a point.
